(19) United States
(12) Patent Application Publication
(10) Pub. No.: US 2009/0017216 A1
(43) Pub. Date: Jan. 15, 2009

(54) RESIN BLENDS WITH WIDE TEMPERATURE RANGE DAMPING

(76) Inventors: Frank Hoefflin, Royal Oak, MI (US); Hua Ning, Rochester, MI (US); Patricia Heidtman, Livonia, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/117,483

(22) Filed: May 8, 2008

Related U.S. Application Data
(60) Provisional application No. 60/916,697, filed on May 8, 2007.

(51) Int. Cl. B05D 1/02; C08F 20/06; C08L 31/04; C04B 24/26; C08F 20/28

(52) U.S. Cl. 427/427.4; 525/232; 525/221; 525/227; 524/524; 524/523; 524/525; 524/522

(57) ABSTRACT

Compositions for damping the vibration of mechanical components, such as those used in vehicles, are disclosed and described. The compositions comprise resin blends that are semi-compatible and which are blended to form a micro-phase separation.

### CROSS-REFERENCE TO RELATED APPLICATION

This application claims the benefit of U.S. Provisional Patent Application No. 60/916,697, filed May 8, 2007, the entirety of which is hereby incorporated by reference.

### FIELD

The present disclosure relates to compositions used to dampen noise and vibration in mechanical structures, and more particularly, concerns compositions that provide damping over a wide temperature range.

### BACKGROUND

Undesirable vibration energy occurs in a variety of products and devices. For example, in automotive vehicles, the engine and other automotive systems can cause vibration to permeate through the vehicle body and into the vehicle's passenger compartment. Similar undesirable vibration energy results in a variety of other situations, such as in household appliances and other types of transportation vehicles, to name a few.

To reduce undesirable vibration energy, vibration damping materials, such as viscoelastic polymer resin materials, may be applied to the surfaces of mechanical components subjected to vibrational disturbances. The viscoelastic state of a polymer is a transition state between the polymer's hard/glassy and soft/rubbery states. Suitable damping materials are typically viscoelastic in the temperature range of interest and dissipate a portion of the vibrational energy applied to them. For vehicle applications, such viscoelastic materials may be applied to a number of surfaces of the vehicle panels, floors, etc. to reduce the vibration or noise felt by the vehicle occupant.

It is generally desirable to select damping materials so that their maximum damping effect coincides with the range of temperatures to which the vibrating surface will be subjected. Many known materials suffer from having a relatively narrow temperature range over which effective damping occurs. Resin blending has been attempted as a means to produce damping over wide temperature ranges. However, previous efforts have been unsuccessful. Thus, a need has arisen for a damper composition that addresses the foregoing.

### BRIEF DESCRIPTION OF THE DRAWINGS

The foregoing brief description, as well as further objects, features and advantages of the present invention will be understood more completely from the following detailed description of presently preferred embodiments, with reference being had to the accompanying drawings in which:

FIG. 1 is a perspective view of a substrate, such as an automotive panel, with a damping composition applied thereto.

FIG. 2 is a graph depicting the Dynamic Mechanical Analysis loss factor (tan D) of two vinyl acetate resin damping compositions and a damping composition comprising an incompatible blend of the two vinyl acetate resins.

FIG. 3 is a graph depicting the composite loss factor (CLF) as determined by the Oberst Test Method for two vinyl acetate resin damping compositions and a damping composition comprising an incompatible blend of the two vinyl acetate resins.

FIG. 4 is a graph depicting the Dynamic Mechanical Analysis loss factor (tan D) of an acrylic resin damping composition, a vinyl acetate resin damping composition, and a damping composition comprising a compatible blend of the acrylic and vinyl acetate resins.

FIG. 5 is a graph depicting the composite loss factor as determined by the Oberst Test Method for a damping composition comprising a blend of acrylic resins, a vinyl acetate resin damping composition, and two damping compositions comprising mixtures of the acrylic resin blend and the vinyl acetate resin in varying proportions, one of which forms a semi-compatible blend.

FIG. 6A is a graph depicting the composite loss factor as determined by the Oberst Test Method for two different acrylic resin damping compositions and a damping composition comprising a compatible blend of the resins.

FIG. 6B is a graph depicting the composite loss factor as determined by the Oberst Test Method for an acrylic resin damping composition, an acrylic/acrylonitrile resin damping composition, and a damping composition comprising an incompatible blend of the resins.

FIG. 6C is a graph depicting the composite loss factor as determined by the Oberst Test Method for an acrylic resin damping composition, a hydroxy-functional acrylic/styrene resin damping composition, and a damping composition comprising a semi-compatible blend of the resins.

FIG. 6D is a graph depicting the composite loss factor as determined by the Oberst Test Method for the compatible, incompatible, and semi-compatible resin blend damping compositions of FIGS. 6A-6C.

FIG. 7 is a depiction of a process for applying a damper composition onto a substrate, such as a vehicle panel.

### DETAILED DESCRIPTION

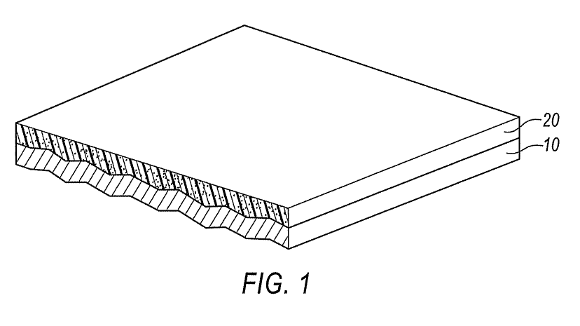

FIG. 1 provides an illustrative example of an article subjected to vibration which has a damping material applied to it. In the example, substrate 10 is generally a metal or other rigid material which is subjected to external vibrational disturbances. For example, substrate 10 may comprise the floor of an automobile which is subjected to vibrational disturbances from the operation of the vehicle engine. Damping material 20 is a viscoelastic coating that is applied to substrate 10 to reduce the amount of vibration experienced by the vehicle occupant due to the vibrational disturbances imposed on substrate 10. Substrate 10 may be a vehicle floor, a portion of a trunk, a portion of a dashboard or other components that experience vibration. Although automotive applications are referred to by way of example, damping material 20 may be applied to any mechanical structures or components that are subjected to vibration, such as household appliances, flooring, machine shells, washer/dryers, airplanes, boats, or various tools.

In addition to a polymer resin, damping material 20 may also comprise other components such as thickeners. Suitable thickeners include alkali-soluble polymers (including but not limited to copolymers of carboxylic acids and acrylic esters), polyvinyl alcohols (“PVOH”), PVOH-stabilized polymers (including but not limited to PVOH-stabilized vinyl acetate polymers such as ethylene-vinyl acetate copolymers and polyvinyl acetate polymers), and polysaccharides (including but not limited to starches and celluloses). In addition, other optional ingredients may be added to damping material 20 to enhance the damping properties and/or improve processing, including but not limited to fillers, defoamers, plasticizers, wetting agents, surfactants, dispersing agents, blowing agents, and microbicides. Suitable fillers could be any non-latex particulate solids either inorganic or organic type. Examples are calcium carbonate, talc, glass fillers, fibers, bubble spheres, barium sulfate, zeolites, mica, graphite, Wollastonites, calcium silicate, clay, mixtures or combinations of the foregoing, and the like.

In damping applications, it is generally desirable to maximize damping across the range of temperatures at which a damped component will operate. In one embodiment involving automotive applications, substrate 10 is subjected to operational temperatures of from about 20° C. to about 60° C. Unfortunately, many known resin systems suffer from having a relatively narrow temperature range over which they effectively dampen vibrations, especially in the range of 20° C. to 60° C. It has been proposed to simply combine resins with different damping-temperature profiles to produce a blend with a broader temperature range of effective damping. However, if the resins are compatible (i.e., miscible), they will typically produce an equally narrow, albeit shifted, effective damping temperature range. Blending resins that are incompatible will typically provide effective damping only within the effective damping temperature ranges of each constituent resin. Thus, the overall temperature range over which effective damping occurs will not be appreciably expanded.

It has been discovered that certain resins can be combined to form “semi-compatible” resin blends with improved damping characteristics. Such semi-compatible blends may also be described as forming a “micro-phase separation,” or “micro-incompatible phases.” As used herein, the terms “semi-compatible,” “micro-incompatible,” and “micro-phrase separation” mean that the mixing of the polymer molecules in the blended resins is extensive but incomplete. As a result, loosely defined domains of the constituent resins are formed in the total mixture, which yields both hard and soft segments in one system upon drying, and the final system would be a multi-constrained layer damping system comprising both a stiff polymeric region and a viscoelastic polymeric region. As used herein the term “resin blend” refers to combining polymeric resins through physical mixing or combining. A “semi-compatible resin blend” is obtained when two or more polymeric resins are physically mixed or combined to obtain micro-incompatible phases and a micro-phase separation. Preferred semi-compatible resin blends are those in which the two or more polymeric resins are fully polymerized, i.e., those blends in which no further polymerization occurs subsequent to physically mixing or combining the resins.

To better understand the behavior of semi-incompatible or micro-incompatible resin blends, the behavior of compatible and incompatible resin blends will first be described. Compatible resin blends are those in which the constituent resins are fully miscible and form a substantially homogeneous mixture. Conversely, incompatible resin blends are those in which the constituent resins are immiscible and form substantially separate phases. One method of distinguishing compatible and incompatible systems is to perform dynamic mechanical analysis (“DMA”) testing and examine the loss factor of the resin blend and the constituent resins. As is known to those skilled in the art, in DMA testing a dynamically varying stress is applied to the material of interest, and the “loss factor”, which is also referred to as “tan delta,” “tan D,” and “tan δ” (i.e., the ratio of the loss modulus to the storage modulus) is determined. On a plot of tan δ versus temperature, the individual resins will typically exhibit a maximum peak. If incompatible resins are blended, the blend will typically exhibit tan δ peaks proximate the peaks of the constituent resins, with reduced damping occurring between the peaks. If compatible resins are blended, the blend's DMA curve will typically have a single tan δ peak between the peaks of the constituent resins. In certain illustrative applications involving the damping of automotive components or surfaces, it is desirable for damping composition 20 to have a loss factor that is generally above 0.8, and preferably above 1.0, over a temperature range of from about 20° C. to about 60° C. In other illustrative applications, the constituent resins comprising the semi-compatible resin blend will each have a corresponding glass transition temperature of from about −20° C. to about 50° C.

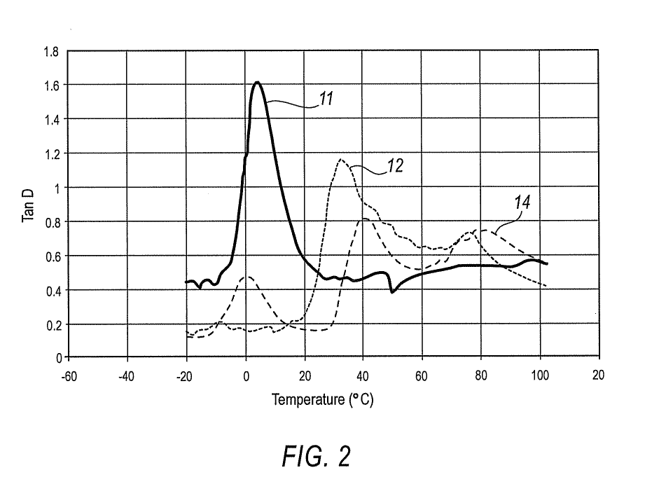

Referring to FIG. 2, DMA results are provided for an exemplary damping composition comprising an incompatible resin blend. In the figure, DMA loss factor (tan D) results are provided for damping compositions comprising a water-based, ethylene-vinyl acetate copolymer (“EVA”) resin 11, a water-based, polyvinyl acetate (“PVAc”) resin 12, and a 50:50 blend 14 of the two individual EVA and PVAc resins used to prepare damping compositions 11 and 12. As used herein, data concerning the ratios of resin components is calculated on a weight basis and includes both the liquid and solid resin components. The EVA resin damping composition 11 comprises a polyvinyl alcohol-stabilized, EVA resin known as Airflex 426, a product of Air Products and Chemicals, Inc. of Allentown, Pa. The PVAc resin damping composition 12 comprises a polyvinyl alcohol-stabilized, PVAc resin known as Mowlith DN 50, a product of Hoechst Celanese AG of Germany. The DMA data of FIG. 2 were generated using a Perkin-Elmer DMA 7E apparatus. For a given resin, the peak loss factor value represents the temperature where maximum damping occurs. Thus, for the EVA resin damping composition 11, maximum damping occurs at a temperature of about 5° C., while the PVAc resin shows two damping peaks, one at about 30° C. and the other at about 75° C. Resin blend damping composition 14 has three loss factor maxima (at about 5° C., 40° C., and about 80° C.) which are proximate the loss factor maxima of damping compositions 11 and 12. The maximum loss factor for EVA and PVAc damping compositions 11, 12 is significantly higher than the corresponding maximum of resin blend composition 14. In addition, the blend's loss factor drops off between its 0° C. and 40° C. peaks, and especially poor damping is observed between the maximum damping temperatures (5° C. and 30° C.) of the constituent resin compositions 11, 12.

In addition to DMA testing, the damping performance of resins and resin blends can also be characterized using the “composite loss factor” or “CLF” as determined by the Oberst Test Method, which is set forth in Society of Automotive Engineers Standard J1637. As is known to those skilled in the art, the Oberst method assesses the damping of a damping material bonded to a cantilevered steel bar. Thus, the CLF is used to evaluate the damping of a resin/substrate system, as opposed to the resin alone, and can be used to evaluate samples under conditions that are representative of passenger vehicle applications.

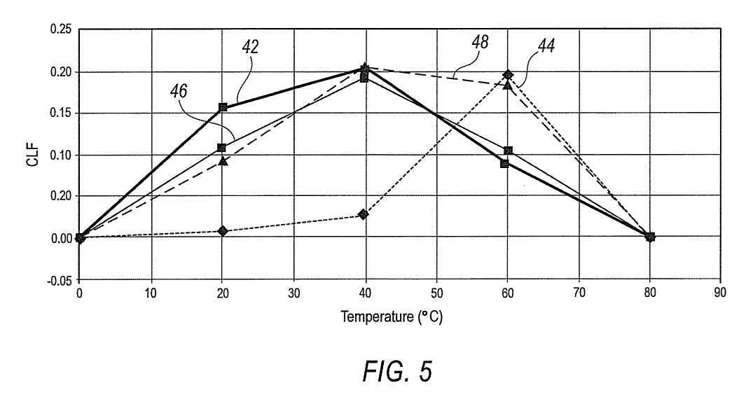

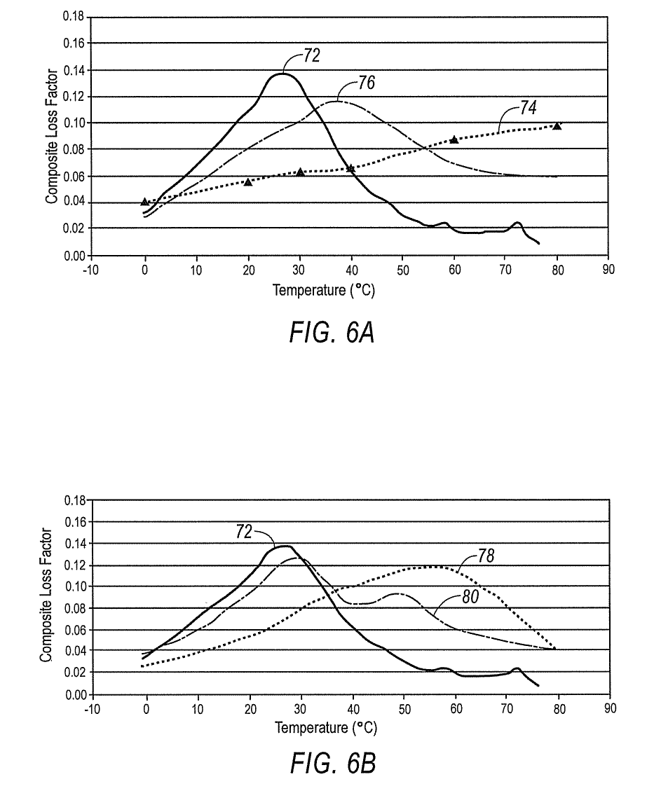

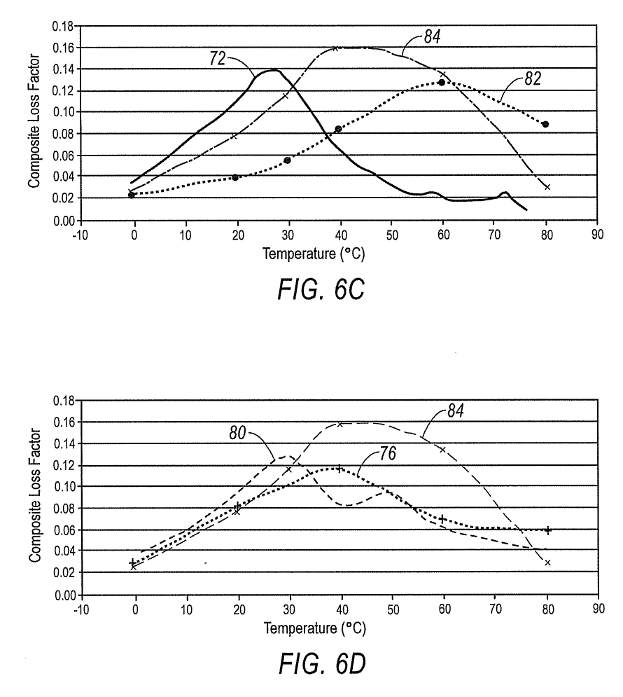

As illustrated further in the examples below, in certain exemplary applications, CLF data may be generated for a damping composition comprising a semi-compatible resin blend as well as for reference damping compositions comprising the individual resins that make up the semi-compatible blend. The first reference composition will comprise one of the resins that forms part of the semi-compatible blend composition, and the second reference composition will comprise the other of the resins that forms part of semi-compatible blend composition. Each reference composition will have a maximum CLF and will attain a specified percentage (e.g., 70%, 75% or 80%) of its maximum CLF over a corresponding temperature range. In certain illustrative examples, the composition comprising the semi-compatible resin blend will have CLF values exceeding the specified percentage of one or both of the reference compositions' maximum CLF values over a temperature range that is wider than the temperature range over which one or both of the reference compositions achieve the same specified percentage of their respective maximum CLF values. This will be illustrated further with reference to FIGS. 5 and 6C below. In comparing CLF data for the constituent resin compositions to the resin blend composition, the amount of resin relative to filler, thickener or other additives is preferably held constant, and the Oberst method test conditions (e.g., size, density, and dimensions of the bar, amount of material applied to the bar, etc.) are preferably held constant.

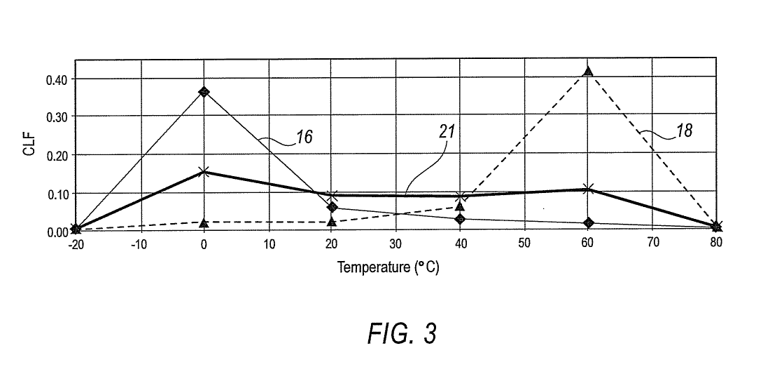

Referring to FIG. 3, CLF values are provided for an incompatible resin blend damping composition. CLF values are provided for a water-based EVA resin damping composition 16, a water-based PVAc resin damping composition 18, and a damping composition comprising a 1:1 blend of the EVA and PVAc resins 21 used to prepare damping compositions 16 and 18. To ensure a consistent basis of comparison, testing on each composition was performed on a cantilevered bar of the same dimensions and density.

EVA copolymer resin damping composition 16 comprises Airflex 920, a polyvinyl alcohol-stabilized, EVA resin with a Tg of −20° C. supplied by Air Products and Chemicals, Inc. PVAc resin damping composition 18 comprises Resyn® SB321, a PVAc resin containing a hydroxyethylcellulose protective colloid which is supplied by Celanese Emulsions of Dallas, Tex. As shown in FIG. 3, EVA copolymer resin damping composition 16 has a CLF peak at about 0° C., with CLF values of greater than about 0.2 between about −10° C. and about +10° C. PVAc resin damping composition 18 has a CLF peak at about 60° C. with CLF values of greater than about 0.2 from about 48° C. to about 70° C. The damping of both resin compositions 16 and 18 the blend 21 drops off between about 20° C. and 40° C., with CLF values falling well below 0.10.

Blending the EVA and PVAc resins of FIG. 3 causes a significant decrease in damping performance. Resin blend damping composition 21 has CLF maxima temperatures that are near the maxima for the EVA and PVAc compositions 16, 18. However, the maximum CLF values for the blend composition 21 are greatly reduced, to about 0.15 at 0° C. and about 0.10 at 60° C. Thus, at least when combined in a 1:1 ratio, blending the Airflex 425 EVA resin and the Resyn® SB321 PVAc resin does not improve damping performance and is believed to produce incompatible phases.

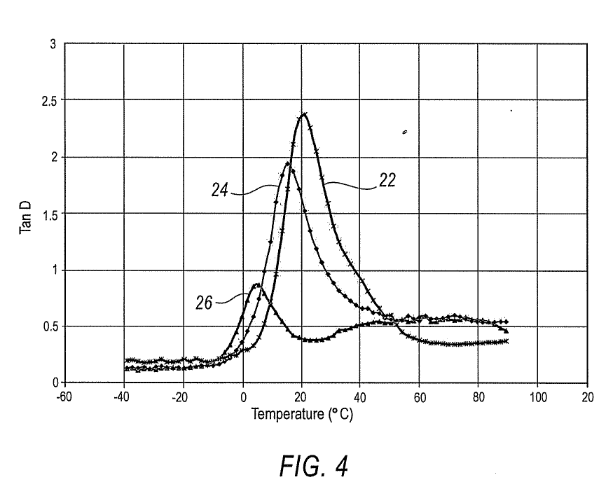

The behavior of compatible resin blends is markedly different than the behavior of incompatible blends. Referring to FIG. 4, DMA results are provided for an EVA copolymer resin damping composition 26, an acrylic resin damping composition 22, and a resin blend damping composition 24 which comprises a compatible blend of the EVA and acrylic resins used to prepare compositions 26 and 22, respectively. Acrylic resin damping composition 22 comprises an acrylic latex supplied by Rohm & Haas. EVA copolymer resin damping composition 26 comprises Dur-O-Set®) E200, a water-based, polyvinyl alcohol-stabilized EVA resin supplied by Celanese Emulsions. Acrylic resin damping composition 22 has a tan D maximum at about 20° C., while EVA resin damping composition 26 has a tan D maximum at about 5° C. Unlike the incompatible blends described previously, compatible resin blend damping composition 24 has a single peak located at about 15° C., between the tan D peaks of EVA and acrylic compositions 22 and 26. Resin blend composition 24 shows improved damping over both individual resins 22 and 26 between about 7° C. and about 15° C. However, at temperatures above 15° C., resin blend composition 24 shows poorer damping than acrylic resin 22. In addition, the tan D of resin blend composition 24 exceeds 1.0 over about a 22° C. temperature span, whereas acrylic resin composition 22 shows similar tan D values over a relatively broader temperature span of about 30° C. Thus, blending the compatible resins does not widen the temperature range over which effective damping occurs. Nor does it improve damping in the 20° C. to 60° C. range which is important for many applications.

As indicated above, unlike the incompatible resin blends of FIGS. 2-3 or the compatible resin blends of FIGS. 4, it has been discovered that certain resins can be blended to widen the temperature range over which effective damping occurs. Without wishing to be bound any theory, it is believed that such blends are neither fully compatible nor fully incompatible. Instead, it is believed that they are semi-compatible blends that form a phase structure that is heterogeneous on the microscopic level. Resins suitable for use in forming semi-compatible blends include acrylics (including acrylic co-polymers), styrene-acrylic co-polymers, styrene-butadiene copolymers, vinyl acetate polymers (including without limitation EVA copolymers and PVAc), and vinyl-acrylic copolymers. Again without wishing to be bound by any theory, it is believed that the difference in the glass transition temperatures of the constituent resins plays a role in determining whether a semi-compatible blend will be formed. It is further believed that the chemical similarities between the constituent resins will affect the formation of a semi-compatible blend. Resins that are chemically similar will tend to form compatible blends. Thus, providing constituent resins with some degree of chemical dissimilarity better ensures that a semi-compatible blend will be formed.

In one embodiment, two water-based resins are blended to form a semi-compatible resin blend. In another embodiment, the semi-compatible resin blend comprises an acrylic resin and a vinyl acetate resin. In a further embodiment, the semi-compatible blend comprises a compatible blend of two acrylic resins combined with a PVAc resin. In yet another embodiment, the ratio of the acrylic resins to the PVAc resin on a weight basis is less than about 3:1. In a further embodiment, the ratio of the acrylic resins to the PVAc resin on a weight basis is not more than about 2.33:1. In still another embodiment, the ratio of the acrylic resins to the PVAc resin on a weight basis is not more than about 2:1.

In one embodiment, the total amount of resin in the damping composition generally ranges from about 15 percent to about 65 percent by weight of the total damping compositions, with a range of from about 25 percent to about 55 percent by weight of the total damping composition being preferred, and a range of from about 35 percent to about 45 percent by weight being more preferred.

FIG. 5 illustrates CLF results for a semi-compatible blend. CLF results are provided for four damping compositions 42, 44, 46, and 48. As explained below, it is believed that damping composition 48 comprises a semi-compatible resin blend.

The CLF results depicted in FIG. 5 were generated using an SAE Oberst test bar having a width of 12.7 mm, a length of 225 mm, and a thickness of 0.8 mm. The root of the test bar was 25 mm and the free length was 200 mm. Damping performance was measured at five temperatures: 0° C., 20° C., 40° C., 60° C., and 80° C. The damping data was interpolated to a frequency of 200 Hz and was linearly interpolated between data points. It is believed that a linear interpolation of the CLF values accurately reflects the damping performance of compositions 42, 44, 46, and 48 between the five data points that were measured. To obtain the CLF data, damping compositions 42, 44, 46, and 48 were hand applied to the test bars at a 3 mm wet film thickness to get 3.0 kg/m² surface coverage. The bars were flashed off overnight at room temperature and baked at about 160° C. for about 30 minutes prior to performing the Oberst test method.

Each of the damping compositions 42, 44, 46, and 48 comprises one or more resins, a filler, and in certain cases, a thickener. In FIG. 5, first damping composition 42 comprises a 50:50 blend of Acronal® DS 2159 and Acronal® DS 3502 acrylic resins supplied by BASF Corporation. Acronal® DS 2159 is an acrylic ester copolymer emulsion having a solids content of from about 49% to about 51%. It forms films having a glass transition temperature of about 12° C. Acronal® DS 3502 is an aqueous dispersion of an acrylic copolymer which has a solids content of from about 54% to about 56%. It forms films with a glass transition temperature of about 4° C. The acrylic resins comprising damping composition 42 formed a compatible blend having a single CLF peak at about 40° C. and CLF values of at least about 0.15 over a temperature range of from about 20° C. to about 48° C. Second damping composition 44 was prepared from a Mowlith DN50 PVAc resin 44 and yielded a maximum CLF value at about 60° C. Second damping composition 44 yielded a CLF of at least about 0.15 over a temperature range of from about 55° C. to about 65° C.

Third damping composition 46 comprises a 3:1 acrylic/PVAc resin blend. The acrylic resin used to prepare damping composition 46 was itself a compatible blend of two compatible resins: a 50:50 blend of Acronal® DS 2159 and Acronal® DS 3502. The PVAc resin used to prepare damping composition 46 was Mowlith DN50. It is believed that when combined in the 3:1 ratio, the acrylic and PVAc resins of third damping composition 46 formed a compatible blend. As shown in FIG. 5, third damping composition 46 yielded a distinct, single CLF peak at about 40° C. In addition, the CLF curve for third damping composition 46 is similar to the CLF curve for first damping composition 42, which comprises a compatible blend of acrylic resins. The CLF value of third damping composition 46 was at least 0.15 over a temperature range of from about 30° C. to about 48° C. Thus, blending the acrylic and PVAc resins in a 3:1 ratio yielded poorer damping performance as compared to first damping composition 42, which as mentioned above, yielded a CLF of about 0.15 from about 20° C. to about 48° C.

Fourth damping composition 48 comprises a 2:1 acrylic/PVAc blend. The acrylic resin used to prepare fourth damping composition 48 was a 50:50 blend of Acronal® DS 2159 and Acronal® DS 3502. The PVAc resin used to prepare damping composition 46 was Mowlith DN50. Unlike the other resin blends discussed previously, fourth damping composition 48 is believed to exhibit excellent damping between the CLF peaks (i.e., between about 40° C. and about 60° C.) of damping compositions 42 and 44 (which comprise the constituent resins of fourth damping composition 48). In addition, fourth damping composition 48 exhibited a CLF value of greater than 0.15 over the temperature range from about 30° C. to about 63° C. Based on the interpolated CLF data, in the range of about 40° C. to about 60° C., fourth damping composition 48 is believed to have maintained a CLF that was about 85% of the maximum CLF of first and second damping compositions 42 and 44. In the range of about 30° C. to about 60° C., fourth damping composition 48 is believed to have maintained a CLF that was about 75% of the maximum CLF of first and second damping compositions 42 and 44. Neither first damping composition 42 nor second damping composition 44 maintained CLF values that were comparable to the interpolated CLF values of fourth damping composition 48 throughout the entire 40° C. to 60° C. temperature range. Notably, at about 52° C., first and second damping compositions 42 and 44 each yielded a CLF of about 0.13, while fourth damping composition 48 yielded a CLF of about 0.18, an increase of about 38%. Without wishing to be bound by any theory, it is believed that the improved damping performance of fourth damping composition 48 is attributable to the formation of a micro-phase separation between the acrylic and PVAc resin constituents.

Methods of preparing the damping compositions 42, 44, 46, and 48 will now be described. In general, the compositions were prepared by combining the resin components to form a pre-mix and then adding a filler material, followed by a thickener. The pre-mix was formed by combining the resin components in a high speed mixer at about 1250 rpm for about 15 minutes. The filler was then added to the pre-mix at a mixing speed of about 800 rpm for about 10 minutes, followed by additional mixing at a speed of about 1200 rpm for an additional 5 minutes. A thickener was then added to certain of the formulations at a mixing speed of about 700 rpm until a homogeneous mixture was obtained.

Although a variety of fillers and thickeners can be used, the filler used to prepare damping compositions 42, 44, 46, and 48 was HuberCarb Q325 CaCO₃ filler. A thickener sold by BASF Corporation under the tradename Latekoll® D was added to damping compositions 42, 46, and 48. Latekoll® D is an alkali-soluble, anionic dispersion of acrylic ester/carboxylic acid copolymer supplied by BASF Corporation. No thickener was required for damping composition 44 because of the relatively high viscosity of the Mowlith DN50 PVAc resin used to prepare it. The amounts of the various resins, filler, and thickener used to prepare damping compositions 42, 44, 46, and 48 are set forth below in Table 1:

TABLE 1

| | | First | | Second | | Third | | Fourth | |
|---|---|---|---|---|---|---|---|---|---|
| | | Damping | | Damping | | Damping | | Damping | |
| | De- | Comp. | | Comp. | | Comp. | | Comp. | |
| Material | scription | 42 | | 44 | | 46 | | 48 | |
| Acronal | Acrylic | 60 | g | | | 45 | g | 40 | g |
| 3502 | resin | | | | | | | | |
| Acronal | Acrylic | 60 | g | | | 45 | g | 40 | g |
| 2159 | resin | | | | | | | | |
| Mowlith DN | Polyvinyl | | | 120 | g | 30 | g | 40 | g |
| 50 | acetate | | | | | | | | |
| Q325 | Filler | 180 | g | 180 | g | 180 | g | 180 | g |
| CaCO₃ from | | | | | | | | | |
| Huber | | | | | | | | | |
| Latekoll D | Thickener | 1.5 | g | | | 1.5 | g | 1.5 | g |

As set forth above, the amount of filler used to prepare damping compositions 42, 44, 46, and 48 was about 60% by weight, yielding a weight ratio of total resin/filler of 2:3. The total amount of all resin components in compositions 42, 44, 46, and 48 was about 40% by weight. The amount of thickener used to prepare damping compositions 42, 46, and 48 was about 0.5%.

Referring to FIGS. 6A-6D, additional examples of CLF data for compatible, incompatible, and semi-compatible resin blend damping compositions are provided. The compositions of the monomeric precursors used to form the constituent resins are set forth in Table 2, below.

TABLE 2

| | Monomer Formulation | | |
|---|---|---|---|
| Resin | (wt. percent) | | Tg (° C.) |
| Resin A | 50% | MMA | 9.21 |
| | 48% | BA | |
| | 2% | MAA | |
| Resin B | 40.95% | BA | 56.72 |
| | 57.55% | MMA | |
| | 1.5% | MAA | |
| Resin C | 24.15% | BA | 27 |
| | 20% | 2-EHA | |
| | 40.35% | MMA | |
| | 14% | AN | |
| | 1.5% | MAA | |
| Resin D | 40.95% | BA | 31 |
| | 4% | HBMA | |
| | 12% | S | |
| | 41.55% | MMA | |
| | 1.5% | MAA | |

MMA = Methyl methacrylate
BA = Butyl methacrylate
MAA = Methacrylic acid
2-EHA = 2-ethyl hexyl acrylate
AN = Acrylontirile
HBMA = Hydroxy butyl methacrylate
S = Styrene

Resins A-D were provided as latexes and used to prepare damping compositions 72-84 by combining them with a filler package, thickener, dispersant and defoamer. The relative amounts of the various components are set forth below in Table 2.

TABLE 3

| Composition | | Filler | | Defoamer & |
|---|---|---|---|---|
| No. | Resins | Package | Thickener | Dispersant |
| 72 | 39.45% A | 59.17% | 0.49% | 0.88% |
| 74 | 39.45% B | 59.17% | 0.49% | 0.88% |
| 76 | 19.72% A | 59.17% | 0.49% | 0.88% |
| | 19.72% B | | | |
| 78 | 39.45% C | 59.17% | 0.49% | 0.88% |
| 80 | 19.45% A | 59.17% | 0.49% | 0.88% |
| | 19.45% C | | | |
| 82 | 39.45% D | 59.17% | 0.49% | 0.88% |
| 84 | 19.45% A | 59.17% | 0.49% | 0.88% |
| | 19.45% D | | | |

Each Composition 72-84 was prepared by first combining its latex resin components to form a pre-mix and mixing in a high speed mixer at 1250 rpm for about 15 minutes. The filler package was then added to the pre-mix at a mixing speed of about 1250 rpm for about 10 minutes, after which mixing was continued for about 10 minutes at a speed of about 1500 rpm. The thickener (Latekoll D) was then added and mixed at a speed of about 1250 rpm until a substantially homogeneous mixture was obtained. CLF testing was performed by hand applying each Composition 72-84 to Oberst test bars that were 200 mm long, 12.7 mm wide, and 1.6 mm thick. The amount applied for each Composition was 3.0kg/sq. meter of bar surface area. After application, the bars were flashed off for 10 minutes at room temperature and baked at 140° C. for 50 minutes. The CLF data was generated and interpolated to 200 Hz at test temperatures ranging from 0° C. to 80° C.

Referring to FIG. 6A, CLF data is provided for Compositions 72, 74, and 76. As FIG. 6A indicates, Composition 72 has a CLF peak of about 0.14 at a temperature of about 27° C. Composition 74 has a CLF peak of about 0.1 at about 80° C., and the resin blend of Composition 76 has a CLF peak of about 0.12 at a temperature of about 37° C. The CLF of Composition 76 exceeded 0.1 (about 70% of the maximum CLF of Composition 72) over a temperature range (ΔT) of from about 30° C. to about 47° C. However, Composition 72 (Resin A alone) achieved the same damping performance over a slightly larger temperature range (from about 17° C. to about 35° C.). In addition, the resin blend of Composition 76 achieved a CLF of about 80% of the damping performance of Composition 72 (i.e., a CLF of about 0.11) over a temperature range of from about 33° C. to about 44° C., while Composition 72 (Resin A) achieved the same damping performance over the relatively wider temperature range of from about 20° C. to about 33° C. Thus, the resin blend of Composition 76 achieved relatively poorer damping performance than Composition 72 alone.

Composition 76 is believed to be a compatible resin blend, at least in part, because it has a single CLF peak between the CLF peaks of compositions 72 and 74, and because it achieved relatively poorer damping performance than Composition A alone. In addition, a compatible blend would be expected because Resins A and B are very similar in composition, being prepared from precursors comprising the same acrylate monomers.

Referring to FIG. 6B, CLF data is provided for Composition 72 and Composition 78, which comprises Resin C. Composition 80 comprises a 50/50 blend (by weight) of Resins A and C. The CLF data for Composition 72 is the same as that of FIG. 6A. Composition 78 has a CLF peak of about 0.12 at a temperature of about 56° C. Composition 80 has two CLF peaks, a first peak of about 0.13 at a temperature of about 30° C., and a second peak of about 0.09 at a temperature of about 50° C. Composition 80 achieved a CLF of about 0.1 (about 70% of the maximum CLF of Composition 72) over a temperature range of from approximately 22° C. to about 37° C., which was slightly narrower than Composition 72 which, as mentioned above, achieved the same damping performance over a temperature range of from about 17° C. to about 35° C. The resin blend of Composition 80 achieved 80% of the maximum CLF of Composition 72 (i.e., about 0.11) over a temperature range of from about 25° C. to about 35° C., which was slightly narrower than Composition 72 which achieved the same CLF over a temperature range of from about 33° C. to about 44° C.

Because it has two distinct CLF peaks, Composition 80 is believed to comprise an incompatible resin blend. Resins A and C are believed to be incompatible, in part, because of the inclusion of 14% (by weight) acrylonitrile in Resin C, which affects the solubility of the resin in the entirely acrylate-based Resin A.

CLF data for a semi-compatible resin blend 84 is provided in FIG. 6C. FIG. 6C includes CLF data for Composition 72 which is the same as that shown in FIGS. 6A and 6B. Composition 82 comprises Resin D, which includes a hydroxy-functional acrylic/styrene copolymer. In one illustrative example, the copolymer is formed from a monomeric precursor comprising at least one hydroxy-functional acrylate monomer. In another illustrative example, the monomeric precursor comprises at least one hydroxy-functional styrene monomer. In addition, the precursor may comprise both hydroxy-functional acrylic monomer(s) and hydroxy-functional styrene monomer(s). Composition 84 comprises a 50/50 blend (by weight) of Resins A and D. As shown in FIG. 6C, Composition 82 has a CLF peak of about 0.13 at a temperature of about 60° C. However, Composition 84 has a CLF peak of 0.16, which exceeds the maximum CLF peaks of both Compositions 72 and 82. In addition, the CLF of Composition 84 exceeded 0.1 over a temperature range of from about 26° C. to about 67° C., which is much wider than the temperature range over which either Composition 72 or Composition 82 achieved a CLF of 0.1. Composition 84 also exceeded a CLF of 0.11 over a temperature range of from about 28° C. to about 66° C., and exceeded a CLF of over 0.14 over a temperature range of from about 34° C. to about 58° C. Neither Composition 72 nor Composition 82 achieved comparable CLF values over temperature ranges of comparable width.

As FIG. 6C indicates, the semi-compatible blend of Composition 84 achieved damping performance that was superior to Compositions 72 and 82. The superior performance of the semi-compatible blend Composition 84 is further highlighted in FIG. 6D which juxtaposes CLF data for resin blend Compositions 76 (compatible), 80 (incompatible), and 84 (semi-compatible). As indicated in Table 2, Resins A and D are both prepared from precursors comprising all acrylate monomers, with the exception of 12% (by weight) styrene in Resin D. The inclusion of styrene in Resin D is believed to impart a degree of incompatibility to Resins A and D. However, it is also believed that this incompatibility is offset, at least in part, by the inclusion of a hydroxyl group via the hydroxy butyl methacrylate component of Resin D. The hydroxyl group is believed to produce hydrogen bonding between Resins A and D.

The damping compositions described herein may be applied to substrates in a variety of ways, including without limitation casting, extrusion, spray coating, and swirl application. However, in a preferred embodiment, they are sprayed on. In the mixing process used to prepare the damping composition, the particle size of the solid components is preferably monitored or controlled to facilitate spraying. The mean particle size is generally less than 300 microns. However, mean particle sizes of less than 100 microns are preferred.

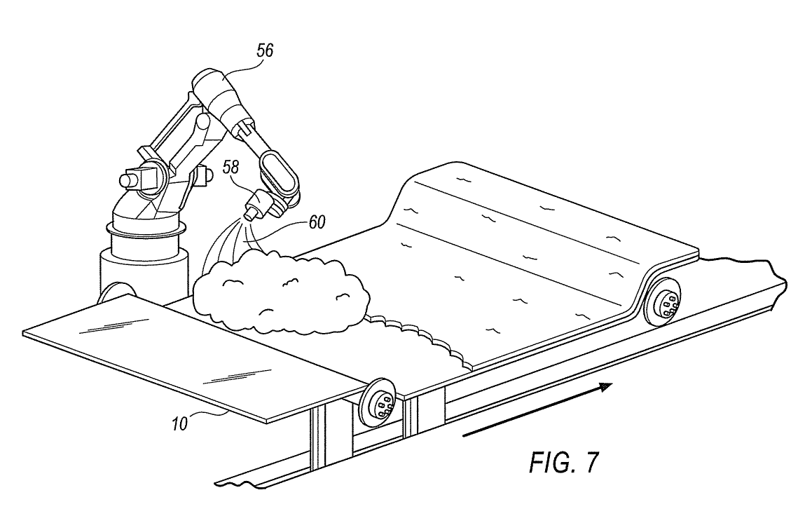

Referring to FIG. 7, a method for applying a damping composition such as those described previously will be described. FIG. 7 depicts an exemplary automated process for applying a damping composition and illustrates a partially-manufactured automotive vehicle on an assembly line. At the illustrated point in the manufacturing process, the automotive vehicle still has a partially-exposed floor panel 10 (substrate) to which a damping composition 60 is being applied. To reduce the amount of vibration experienced in the cabin of a vehicle in which floor panel 10 is installed, it is desirable to include a vibration damper on floor panel 10. FIG. 7 illustrates a process of applying a damping composition onto floor panel 10 by spraying the damping composition with articulated robot arm 56. The damping composition is preferably formed from a semi-compatible blend of resins of the type described previously. In one embodiment, the semi-compatible resin blend comprises a blend of acrylic resins combined with a PVAc resin, wherein the weight ratio of acrylic resins/PVAc resin is less than about 3:1. In a preferred embodiment, the weight ratio of acrylic resins/PVAc resin is not more than about 2.33:1, while in an especially preferred embodiment the weight ratio of acrylic resins/PVAc resin is not more than about 2:1. The damping composition 60 preferably comprises a filler of the type described previously, which is present in an amount ranging generally from about 30% to 70% by weight of the damping composition, with filler amounts of about 35% to about 45% being preferred and an amount of about 40% being especially preferred. In a preferred embodiment, the damping composition is damping composition 48 described above with respect to FIG. 5. Damping composition 60 may also include thickeners or other additives of the type described previously.

In another illustrative example, damping composition 60 comprises a semi-compatible blend of an acrylic copolymer resin and an acrylic/styrene copolymer resin. Damping composition 60 may also include the amounts of filler described above, as well as thickeners and/or other additives of the type described above. In a further illustrative example, the acrylic/styrene copolymer resin is a hydroxy-functional acrylic/styrene copolymer resin prepared by copolymerizing a hydroxy-functional acrylate monomer with styrene and one or more additional acrylate monomers. The copolymer resin may also be prepared from one or more hydroxy-functional styrene monomers in lieu of or in addition to a hydroxy-functional acrylate monomer. In yet another illustrative example the monomeric precursor used to form the hydroxy-functional acrylic/styrene copolymer resin comprises from about 1% to about 10% by weight of a hydroxy-functional acrylic monomer. In still another illustrative example, the acrylic monomers of the monomeric precursor used to prepare the hydroxy-functional acrylic/styrene copolymer generally comprise from about 80% to about 95% by weight of the total monomeric precursor, with amounts ranging from 82% to 92% and 86% to 90% being preferred and more preferred, respectively. In accordance with the example, styrene generally comprises from about 5% to about 20% by weight of the total monomeric precursor, with amounts ranging from about 8% to about 16% and from about 10% to about 14% being preferred and more preferred, respectively. In yet another illustrative example, the acrylic/styrene copolymer resin is Resin D identified in Table 2 above and the acrylic copolymer resin is Resin A identified in Table 2 above.

Referring again to FIG. 7, articulated robot arm 56 has an applicator head 58 with a nozzle for dispensing damping composition 60 in fluid form. The articulated robot arm 56 is electronically controlled by a control device (not shown) such as, for example, a computer workstation. The articulated robot arm 56 is controlled so that the robot arm is selectively positioned relative to the floor 10 of the automotive vehicle to dispense material thereon.

The applicator head 58 disposed on the articulated robot arm 56 is fluidly connected to at least one source of fluid material (not shown). In some embodiments, the sources of fluid materials are drums or bulk containers of fluid materials. Various known metering and fluid delivery components and systems can be used to deliver desired amounts of the fluid materials from the respective sources to applicator head 58. In an embodiment, after fluid materials 60 are applied, volatile components are flashed off by allowing fluid materials to dwell at room temperature for about 20 minutes to about 40 minutes. Floor 10 (or another component of a vehicle in which floor 10 is installed) may then be painted a desired color. After painting, floor 10 is placed in a paint oven to bake the applied paint. The bake oven temperature will range generally from about 120° C. to about 180° C. In one exemplary embodiment, a paint oven temperature of about 160° C. is used. The bake time will generally range from about 10 minutes to about 90 minutes. In an exemplary embodiment, a bake time of 30 minutes is used.

Floor 10 may then be installed in a vehicle that is subject to vibrational disturbances. When the vehicle is in operation, it will transmit vibrations to the floor 10. However, the damping material 20 (FIG. 1) described herein will dampen the transmitted vibration and reduce the amount of vibration experienced in the vehicle cabin. As indicated previously, the temperatures to which the vehicle is subjected may affect the degree of damping provided by a damping composition. However, unlike many prior art damping compositions, the semi-compatible resin blends described herein beneficially increase the temperature range over which effective damping occurs.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. The embodiments should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

With regard to the processes, methods, heuristics, etc. described herein, it should be understood that although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes described herein are provided for illustrating certain embodiments and should in no way be construed to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A damping composition, comprising a semi-compatible resin blend.

2. The damping composition of claim 1, wherein the total amount of resin ranges from about 15 percent to about 65 percent by weight of the total damping composition.

3. The damping composition of claim 1, further comprising at least one filler, wherein the at least one filler is present in an amount ranging from about 30 percent to about 70 percent by weight of the total damping composition.

4. The damping composition of claim 1, wherein the semi-compatible resin blend comprises at least one resin having a glass transition temperature of from about −20° C. to about 50° C.

5. The damping composition of claim 1, wherein the semi-compatible resin blend comprises first and second resins, wherein each of the first and second resins is selected from the group consisting of acrylic resins, acrylic copolymer resins, styrene-acrylic copolymer resins, styrene-butadiene copolymer resins, polyvinyl acetate resins, and vinyl-acrylic copolymer resins.

6. The damping composition of claim 5, wherein the semi-compatible resin blend comprises a first blend of acrylic resins combined with a polyvinyl acetate resin.

7. The damping composition of claim 1, wherein the semi-compatible resin blend comprises a first acrylic copolymer resin and a second acrylic/styrene copolymer resin.

8. The damping composition of claim 7, wherein the first acrylic copolymer resin is prepared from a monomeric precursor comprising methyl methacrylate, butyl acrylate, and methacrylic acid.

9. The damping composition of claim 7 wherein the second acrylic/styrene copolymer resin is prepared from a monomeric precursor comprising at least one of a hydroxy-functional acrylic monomer and a hydroxy-functional styrene monomer.

10. The damping composition of claim 9, wherein the hydroxy-functional acrylic monomer is hydroxy butyl methacrylate.

11. The damping composition of claim 10, wherein the acrylic/styrene copolymer resin is formed from a monomeric precursor comprising butyl acrylate, hydroxy butyl methacrylate, styrene, methyl methacrylate, and methacrylic acid.

12. The damping composition of claim 1, wherein the semi-compatible resin blend comprises a first resin and a second resin, and wherein in a first temperature range the damping composition has a composite loss factor that is at least about 70% of at least one selected from a first maximum composite loss factor for a first reference composition and a second maximum composite loss factor for a second reference composition, the first reference composition comprises the first resin but not the second resin, and the second reference composition comprises the second resin but not the first resin.

13. The damping composition of claim 12, wherein in a second temperature range the first reference composition has a composite loss factor that is at least about 70% of the first maximum composite loss factor, in a third temperature range the second reference composition has a composite loss factor that is at least about 70% of the second maximum composite loss factor, and the first temperature range is greater than at least one selected from the second temperature range and the third temperature range.

14. The damping composition of claim 12, wherein in the first temperature range, the damping composition has a composite loss factor that is at least about 75% of at least one selected from the first maximum composite loss factor and the second maximum composite loss factor.

15. The damping composition of claim 14, wherein in a second temperature range the first reference composition has a composite loss factor that is at least about 75% of the first maximum composite loss factor, in a third temperature range the second reference composition has a composite loss factor that is at least about 75% of the second maximum composite loss factor, and the first temperature range is greater than at least one selected from the second temperature range and the third temperature range.

16. The damping composition of claim 12, wherein in the first temperature range, the damping composition has a composite loss factor that is at least about 80% of at least one selected from the first maximum composite loss factor and the second maximum composite loss factor.

17. The damping composition of claim 16, wherein in a second temperature range the first reference composition has a composite loss factor that is at least about 80% of the first maximum composite loss factor, in a third temperature range the second reference composition has a composite loss factor that is at least about 80% of the second maximum composite loss factor, and the first temperature range is greater than at least one selected from the second temperature range and the third temperature range.

18. A damping composition comprising a blend of a first polymeric resin and a second polymeric resin, wherein the first polymeric resin comprises an acrylic copolymer, and the second acrylic resin comprises a hydroxy-functional acrylic/styrene copolymer.

19. The damping composition of claim 18, wherein the hydroxy-functional acrylic/styrene copolymer is prepared from a monomeric precursor comprising at least one selected from a hydroxy-functional acrylic monomer and a hydroxy-functional styrene monomer.

20. The damping composition of claim 18, wherein the acrylic copolymer of the first polymeric resin is prepared from a monomeric precursor comprising methyl methacrylate, butyl acrylate, and methacrylic acid.

21. The damping composition of claim 18, wherein the hydroxy-functional acrylic/styrene copolymer is prepared from a monomeric precursor comprising butyl acrylate, hydroxy butyl methacrylate, styrene, methyl methacrylate, and methacrylic acid.

22. A damping composition, comprising one or more acrylic resins and a polyvinyl acetate resin, wherein the weight ratio of the one or more acrylic resins to the polyvinyl acetate resin in the damping composition is less than about 3:1.

23. The damping composition of claim 22, wherein the weight ratio of the one or more acrylic resins to the polyvinyl acetate resin in the damping composition is not more than about 2:1.

24. The damping composition of claim 22, wherein the one or more acrylic resins comprises a blend of acrylic resins.

25. The damping composition of claim 22, wherein the one or more acrylic resins and the polyvinyl acetate resin form a semi-compatible resin blend.

26. A vibration damped system, comprising:
a substantially rigid substrate having the damping composition of claim 1 applied thereon, wherein the rigid substrate is subjected to vibrational disturbances.

27. A method of manufacturing a product having a vibration-dampened substrate that is subjected to vibrations, the method comprising:
providing the substrate;
providing a damping composition comprising a semi-compatible resin blend; and
applying the damping composition to the substrate.

28. The method of claim 27, wherein said applying the damper composition to the substrate comprises spraying the damping composition on the substrate.

29. The method of claim 27, wherein the semi-compatible resin blend comprises a first blend of acrylic resins combined with a polyvinyl acetate resin.

30. The method of claim 27, wherein the semi-compatible resin blend comprises a first acrylic copolymer resin and a second acrylic/styrene copolymer resin.

31. The method of claim 30, wherein the first acrylic copolymer resin is prepared from a monomeric precursor comprising methyl methacrylate, butyl acrylate, and methacrylic acid.

32. The method of claim 30, wherein the second acrylic/styrene copolymer resin is prepared from a monomeric precursor comprising at least one selected from a hydroxy-functional acrylic monomer and a hydroxyl-functional styrene monomer.

33. The method of claim 32, wherein the hydroxy-functional acrylic monomer is hydroxy butyl methacrylate.

34. The method of claim 30, wherein the second acrylic/styrene copolymer resin is prepared from a monomeric precursor comprising butyl acrylate, hydroxy butyl methacrylate, styrene, methyl methacrylate, and methacrylic acid.

35. The method of claim 27, wherein in a first temperature range, the damping composition has a composite loss factor that is at least about 70% of one selected from a first maximum composite loss factor for a first reference composition and a second maximum composite loss factor for a second reference composition, the damping composition comprises a first polymer resin and a second polymer resin, the first reference composition comprises the first polymer resin but not the second polymer resin, and the second reference composition comprises the second polymer resin but not the first polymer resin.

36. The method of claim 35, wherein in a second temperature range the first reference composition has a composite loss factor that is at least about 70% of the first maximum composite loss factor, in a third temperature range the second reference composition has a composite loss factor that is at least about 70% of the second maximum composite loss factor, and the first temperature range is greater than at least one selected from the second temperature range and the third temperature range.
